(19) United States
(12) Patent Application Publication
(10) Pub. No.: US 2006/0047572 A1
(43) Pub. Date: Mar. 2, 2006

(54) Text and multimedia messaging-based layered service and contact method, auction method and method of conducting business

(76) Inventors: Jeffery Moore, Seattle, WA (US); Ian Eisenberg, Seattle, WA (US)

Correspondence Address: John P. Iuther;Newman & Newman LLP, Suite 610, 505 Fifth Avenue South, Seattle, WA, 98104, US

(21) Appl. No.: 11/089,812

(22) Filed: Mar. 25, 2005

Related U.S. Application Data
(63) Continuation-in-part of application No. 10/926,701, filed on Aug. 26, 2004.

(51) Int. Cl. G06Q 30/00

(52) U.S. Cl. 705/14

(57) ABSTRACT

The present invention is directed to a method and system for accommodating a person's desires of meeting, locating and/or attracting others for dating, contact or human discourse, or a person's desires of acquiring certain objects or collectibles, or news in general, or business, financial, or sports/betting information and the like, or any combination thereof, by a person placing or answering an advertisement on the Internet or other publicly accessible medium and being appraised of one more responses thereto by SMS, EMS, and/or MMS messaging.

### RELATED APPLICATIONS

This application is a continuation-in-part application of co-pending U.S. patent application Ser. No. 10/926,701 filed Aug. 26, 2004.

### COPYRIGHT NOTICE

Copyright 2005 Blue Frog Mobile, Inc. All rights reserved. A portion of the disclosure of this patent application/patent disclosure and/or patent document contains material which is subject to copyright protection. The copyright owner has no objection to the facsimile reproduction by anyone of the patent document or the patent disclosure as it appears in the United States Patent and Trademark Office file and records.

### FIELD OF INVENTION

The present invention relates to methods of offering and selling multiple or layered tiers of services and goods employing wireless text and/or multimedia messaging in remote transactions in which services and/or goods are ordered or purchased via mobile phone devices in conjunction with Short Message Service (SMS) messages or Multimedia Messaging Service (MMS) messages from merchants or service providers. The present invention also provides an SMS and/or MMS-based auction method for goods and/or services.

### BACKGROUND OF THE INVENTION

Mobile telephone services, such as mobile dating services, chat room services and other mobile match-making services and/or telephonic access to the remote purchase of various services, goods and information in general, has exploded in recent years with concomitant technological flexibility and expanded options. For example, some service providers have employed mobile dating services which resemble instant messaging software, such as ICQ and Yahoo Messenger, but which uses text-only name interface. Such service allows people, for example, to create personal profiles, search for dates, engage in conversations, and engage in other contact through SMS messaging. Some services have now offered SMS “value added” messages, which enable users to access content ranging from news and stock prices to travel information. Such value-added SMS text messaging services have seen increases of customer sent SMS messages by more than five times the rates previously seen, with associated revenues increasing proportionately. Financial performance has been reported to be in excess of one million dollars per month in such value-added or additional data revenue. Reports predict such revenue increases to be merely skimming the surface in terms of what may be reaped from potential service subscribers. Others regret that such dating applications and value-added data presentation/availability was not introduced to pre-paid mobile customers years ago to capture a portion of this immense potential revenue stream and opportunity.

In an example of one Czech-based SMS dating pre-paid service, www.seznamka.cz, described as the largest Czech dating site, an SMS dating service allows one to post, search, and read advertisements as well as to receive and delete replies to one's own advertisement. In this service, the employ of abbreviated codes is said to make it easier to browse through a database, for example, by forwarding SMS text messages to “7777”, commonly referred to as short codes.

In another example model, single people subscribe to a service online, or by SMS text messaging over their cell phones. Applications are filled out, for example, with their profiles, personal information, personal interests and the like, and perhaps pictures are posted as well. When in travel or other out-places a user may ping the service asking for compatible singles in a particular area. After notifying other members nearby, the system would then provide the user with a list of people in close proximity and their location.

In additional examples, SMS.ac, a San Diego based services provider, hosts an online community of wireless messaging users and offers a dating service in which users send SMS text notes to people whose profile interests them; and a Los Angeles based media company using a system called DateTrak, described as a permission-based system, enables users to anonymously search for people who share interests and their real-time locations, and which employs a proprietary technology referred to as “location tracking”.

As may be seen, the potential market and application for new and innovative message-based dating services, such as SMS text message-based services and its progeny Multimedia Messaging Service (“MMS”)-based services, optionally coupled with information/data transmission methods and systems (“value-added services”), is immense, with the existing potential for a broad array of far-ranging applications and embodiments limited only by one's imagination.

### SUMMARY OF THE INVENTION

In accordance with the present invention, there is provided a method and system for accommodating a person's desires of meeting, locating and/or attracting others for dating, contact or human discourse, or a person's desires of acquiring certain objects or collectibles, or news in general, or business, financial or sport/betting information and the like, or any combination thereof, by a person placing or answering an advertisement on the Internet or other public medium. Upon receiving one or more positive replies from a member or members of the public at large, along with any other information of interest, such as personal information or certain product information, financial or business information and the like, the person placing the initial advertisement or inquiry is contacted by one or more SMS text messages, or one or more MMS messages (multimedia messages) from a service provider alerting the person of such positive interest. Further, the person is provided with contact information or other information of the interested party, or party with positive product news and the like. The service provider may charge an assortment of fees for such services, or for enabling any of such events. Additionally, an array of other information may also be provided, such as news, financial reports, sports/betting and/or lottery results and the like as value-added content, again optionally coupled with additional fee payment, and/or one or more products or services may be forwarded to and downloaded via a text message to a customer's mobile phone, such as customized, or custom-made, ringtones, wallpaper for use with one's phone display, games, interactive sports capability, financial products, personal histories, automotive and product histories, animations and displays and the like. Further, the present invention also provides an SMS and/or MMS text and multimedia-based auction method for goods and services which can reach anyone with SMS and/or MMS phone capability virtually anytime for maximum reach and effectiveness.

The invention is more fully understood with reference to the following Detailed Discussion of Preferred Embodiments with accompanying drawings.

### BRIEF DESCRIPTION OF THE DRAWINGS

FIG. 1 illustrates by schematic diagram, an embodiment of a mobile phone device user's purchase of services and/or goods in accordance with the present inventive method and system.

FIG. 2 illustrates by schematic diagram, another embodiment of a mobile phone device user's purchase of services and/or goods in accordance with the present inventive method and system.

FIG. 3 illustrates an additional embodiment of the present invention.

### DETAILED DISCUSSION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

In accordance with a preferred embodiment of the present inventive process and system, a person desirous of meeting, locating or otherwise attracting others for dating, conversation, or any type of personal contact possible, may decide to place a personal advertisement with a vendor service, such as a dating service, chat service, match-making or personal introduction service, or perhaps a personnel service or business. Such advertisement is thereafter made available to the public by any number of ways, such as through the Internet by web page means, or in selected newsletters, in television advertisements or by radio and the like, all of which are contemplated for reaching one or more members of the public with the person's advertisement or personal information or other queries. Upon receiving a reply from one or more members of the public, along, for example, with any information of interest, such as personal contact information, remarks to the person's advertisement or queries and the like, and other personal description etc., the original placer of the advertisement is then contacted or reached by the service provider via a short Message Service (“SMS”) text message (hereinafter “text” or “SMS message”), or an EMS or Multimedia Messaging Service (“MMS”) message (hereinafter “multimedia message” or “MMS message”) with text, graphics, images, animations, pictures, audio or a combination thereof alerting the person of such reply(s) and/or other expressed queries or interest (hereinafter “positive” replies), and optionally an abbreviated or short summary of the nature of such. The advertisement placer is also preferably concomitantly or simultaneously offered a route or means of contact to those persons replying, or perhaps a means to access a more complete description of the repliers' exact nature of interest or query, such as a telephone number, address, web page, or e-mail address. All or portions of the above events or transactions may be accomplished upon payment of a vending fee. Payment may be conducted or consummated through a provided telephone number, an Internet web page or any other conventional or non-conventional (i.e. proprietary) means, such as, for example, a money-card purchase transaction as disclosed in U.S. patent application Ser. No. 10/637,315, filed Aug. 7, 2003.

Further, the method and system may be offered in such a way as to require a service fee from both, or either, the original advertisement placer and/or those whose interest is piqued, or are desirous of replying to a personal advertisement for whatever reason. Both routes of service fee extraction may be accomplished with sending and/or placement of an SMS, EMS and/or MMS message, for example, to alert one or more repliers or potential repliers, or maybe one or more personal advertiser, that, for instance, based upon a prior application or data sheet, they may be interested in replying or contacting one or more persons. In this respect, SMS, EMS and MMS text, graphics, animation, image and audio messaging offers and makes possible virtually unlimited versatility and flexibility, as well as any sort of urgency, or “time is of the essence” situation as desired or contemplated.

One may conveniently envision the aforementioned contemplated situation or situations, or endeavors, as applied to the present invention, as a “fishing expedition” of sorts with the advertisement placer(s) and/or replier(s), the clients and vending service the charter captain or charter service which enables such “big game” fishing and its prizes and rewards for fees, and which alerting and contact functions are conveniently communicated by SMS, EMS and/or MMS messaging, which may reach anyone enabled with such capability (which is now commonplace), anywhere at anytime, to satisfy virtually any desire, need, requirement or whim of anyone so desirous.

The invention and system, aside from one's whims and desires, also provides and makes possible a wealth of highly useful and practicable possibilities, especially those related to business, the professions and trades, or, for example, even the serious collector at large.

For example, in one contemplated embodiment there is provided a chat, dating, matchmaking, or other meeting service or business or service directed, or otherwise devoted, to finding or locating potential matches of particular qualifications, such as a select race, religion, personal preferences or perhaps gene or blood type for ancestral or health reasons to avoid potential genetic disorders, such as the onset of sickle cell anemia disease of the blood and the like. A user may place one or more advertisements with a vendor who may then alert the advertisement placer via SMS, EMS and/or MMS messaging as to replies, queries or comments of an interested party or group with respect to such advertisement with its particularities and qualifications, and supply contact information and the like, all in accordance with a contemplated fee schedule. As will be appreciated by anyone afflicted with, or possibly susceptible to, genetic disorders, the inventive method and service will be able to reach and contact an immense group of potential recipients throughout the world and provide ultra timely contact as desired. A search for transplantable organs from suitable donors, or a timely notification to those in wait for organs will be advantageously enabled by the instant invention as well. Put another way, anyone of whatever background and ilk will appreciate the advantageous immediacy and timeliness afforded by the present invention and the extent of the audience possibly contacted by a placer of advertisements, and the absolute discreetness afforded by the invention as well to those desirous of not placing public advertisements and possibly alerting others in a public forum to their desires, wares and results contemplated or sought, thereby providing in many instances distinct and considerable business and personal advantageous.

In another contemplated embodiment, the present inventive method and system in use may be advantageously employed by the collector and discriminating collector alike to let it be known, as discreetly as desired, via an SMS, EMS and/or MMS message in accordance with the invention, personal contact information along with products or services and the like available or those desired, and other information such as respective price ranges which are acceptable or desired, or any information whatsoever designed to further entice an advertisement placer to pay a fee for contact information of a replier or potential replier. For example, in the case of someone looking for a certain vintage guitar, a vendor service via an SMS/MMS message in accordance with the invention will allow an advertiser seeking such a product know discreetly that a certain person is interested in selling such an object, or perhaps a similar item, or may be seeking a similar item in trade.

As will be appreciated, those persons seeking any person, object or service, be it mates, chat partners, companions, partners, goods, such as autos, old and new, coins, legal briefs, old examination papers, or collectibles, artwork, equipment of any sort, material of any sort or services of any sort may advantageously and conveniently locate and procure such via the SMS, EMS and/or MMS messaging-based method and system of the instant invention, as discretely as desired and without engaging in a bidding war with third parties, such as one may encounter with conventional services and methods now used extensively on the Internet.

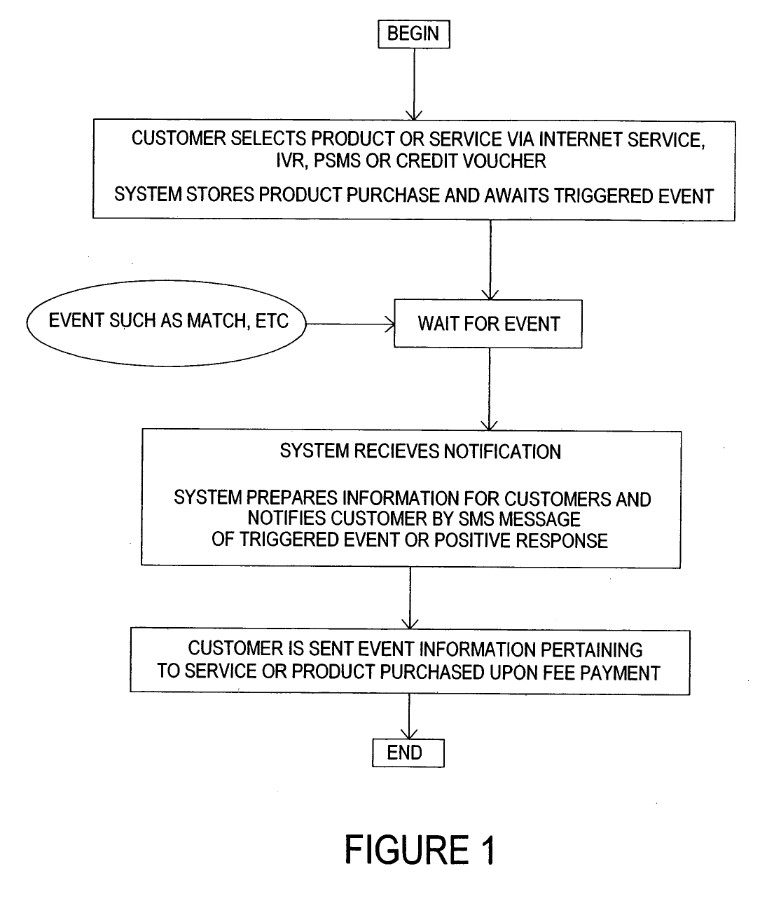

Referring now to FIG. 1, there is illustrated in schematic flow-chart depicting a preferred embodiment of the invention. In this example, a customer first selects a service or product through an Internet-based service, IVR, PSMS or credit voucher, and the selection data is stored. A triggering event with respect to, or otherwise responsive to, the initial request is then waited for to occur, such as a positive personal dating match inquiry or the notification of the availability of a certain product, collectable and the like. Upon notification of a data collection system or other receiver method or system, such as an inquiry processing center, the inquiry is collected, processed and prepared for dissemination to the customer submitting the initial request, who is first forwarded an SMS, EMS and/or MMS message that s/he has received a positive response, such as an interested personal connection, or that a certain rare collectable is available for a certain price or terms. The text or multimedia message may also state that more information, such as contact information and the like, will be provided by a selected means as agreed, and advise of a fee payment schedule or options to receive and to continue to receive such services.

Once a fee is paid and pertinent information is disseminated to the initial customer, such as the positive dating match or inquiry, it is now up to the customer and individual replying to consummate any transaction. However, the customer will always be alerted as to availability of interested persons, or goods and/or services and the like. More importantly, the initial customer in accordance with the present invention will always be able to offer a final bid if third parties become involved and are interested, for example, in the same rare collectable, unlike conventional on-line auctions, such as eBay where a last minute, or even last second bidder or “sniper” may submit a low or objectively inconsequential bid, but unopposed which will win the object desired. In other words, in the present inventive method and system using text and/or multimedia messaging, a customer may be alerted to a triggering event, preferably substantially immediately, virtually at any place and time and invited to affirmatively act upon the event to meet or at least contact another person, or for example, to acquire a special object of interest.

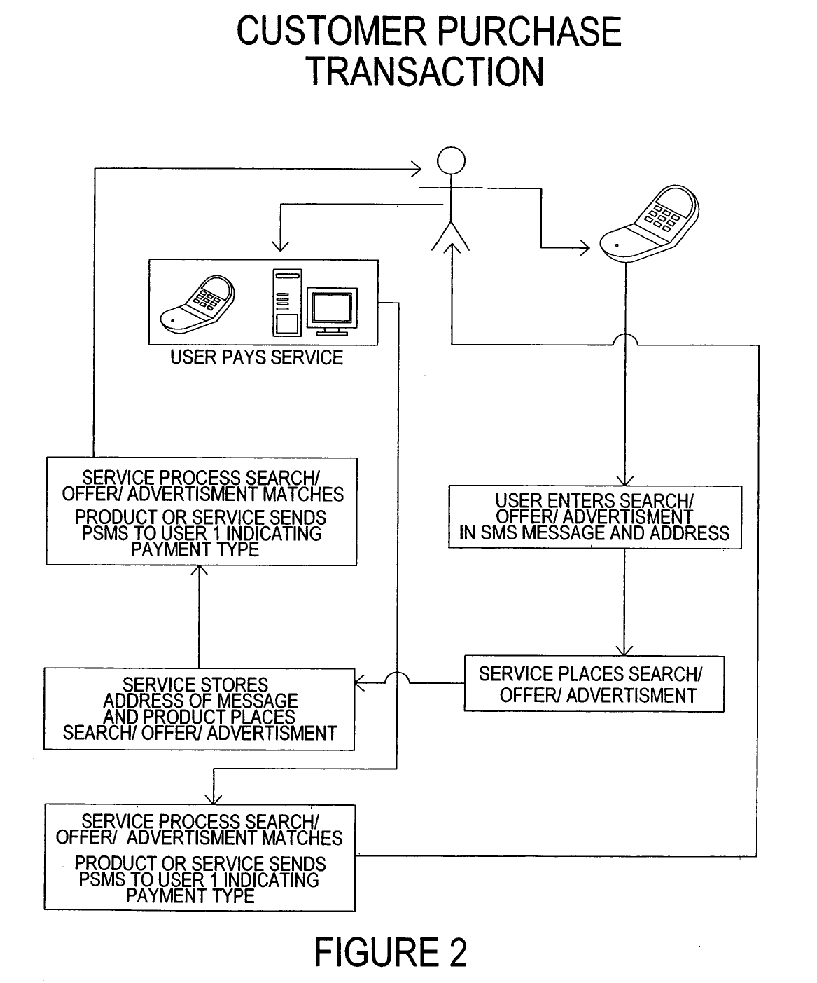

Referring to FIG. 2, there is illustrated a typical customer purchase transaction embodiment in accordance with the invention. Here, a customer by way of, for example, a mobile phone device, enters a search or offer, or other advertisement, by placing a call, or in a text or multimedia message, or on the Internet at a website or through e-mail and the like with a service provider. The service provider stores the address of the customer and other contact information and the content of the message, and then places the search, offer or advertisement in a publicly accessible medium, such as a website, magazine, newspaper, e-mail, television or radio. Upon a triggering event, such as a positive response to the advertisement from another interested person or persons, the service provider contacts the customer, for instance, by an SMS or MMS message with the news of such positive response, preferably substantially immediately, and also indicates a fee payment and type to receive further information to enable the customer and positive responder to consummate a connection of some sort. A fee payment request may also be made by the service provider to the customer while initially placing the advertisement. The customer then pays the service as agreed, and the service provider sends via a text or multimedia message contact information and the like, and if agreed to, for example, upon additional fee payment the service provider will continue to contact the customer with news of additional positive responses to the advertisement.

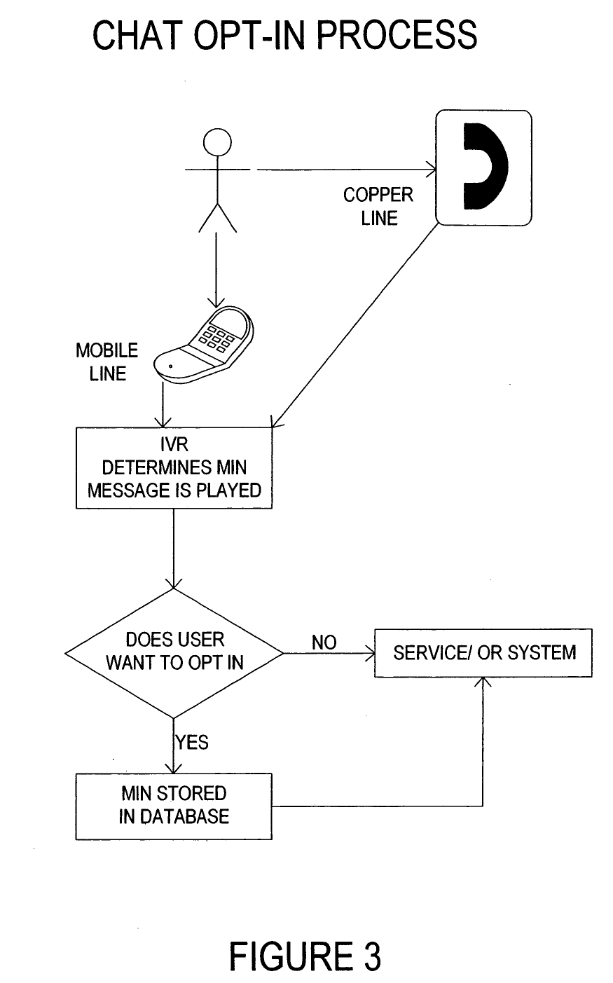

In yet another preferred embodiment, the inventive method and system is provided with opt-in and/or opt-out features for compliance with Federal Trade Commission regulations. Referring now to FIG. 3, as shown, upon the occurrence of a triggering event or prior to such occurrence, such as during initial subscription or during any billing mechanism or billing event, any user of the inventive method and system, or otherwise subscribers to commercial mobile services, are provided the ability to avoid receiving mobile service commercial messages, unless, of course, the subscriber has provided express prior authorization to the service. In a further additionally preferred embodiment, a subscriber/user recipient of mobile service commercial messages is provided means to indicate electronically a desire not to receive further mobile service commercial messages from the sender service. As used herein, the phrase “mobile service commercial message” refers to a commercial electronic mail message that is transmitted directly to a wireless device that is utilized by a subscriber of commercial mobile service, as such term is defined in section 332 (d) of the Communications Act of 1934 (47 U.S.C. 332 (d)) in connection with such service.

In another aspect of the invention, as an illustrative example for use with such above described embodiments, a service provider may place an advertisement in a magazine, or other public medium, which may offer any service and/or product, such as a dating service and the like, which may state,
“Send a text or multimedia message to the provided number and possibly include you picture if you want to date, or chat or find that special someone or friend, or perhaps locate that vintage auto that you have been looking for. Our fee is only 99 cents for each message, or message packages may be purchased separately.”

An interested person viewing the advertisement may decide to respond, and forward an SMS text message from a mobile phone device, for example, using an appropriate product code to the service in response to the advertisement. Next, the service provider may respond to the interested person via a text or multimedia message, and may, for example, query the interested party whether they are sure that they want to sample the service and various of its features with a fee of, say, 99 cents per SMS text message, and perhaps more for MMS messages, received from the service provider. At this point, or any point in the process, for example, before, during or after a billing event or cycle, the would-be customer may be given an opportunity to “opt-in”, or “opt-out” of subscribing to the service, or of receiving additional text or multimedia messages from the service, or if the customer decides to subscribe to the service via an SMS text message s/he may also be given the opportunity to unsubscribe at any point in time as desired. The service may provide or offer any type of product or offer any type of product or information or other services which may be transferred by wireless or wireline phone service to a customer or potential customer.

Upon subscribing to the service the customer may next be queried by a service provider-sent text or multimedia message as to specific desires and/or objectives, or perhaps as to personal information, such as race, gender, gender preference, age, weight, height, smoking habits, drinking habits, occupation, education, salary, and such requirements as to other potential partners and the like, such as to provide a service provider with objective “match” criteria. Following this exercise, including such information transmission, upon the service provider's determination, for example, that a criteria-driven comparison has resulted in one or more objectively compatible-predicted matches or a probable “fit” with the subscriber and others, the service may next forward an SMS or MMS message to the subscriber informing of such a fit. At this point the customer may then be offered various options, such as, for example, (i) paying a fee for each service-forwarded SMS and/or MMS message informing of criteria related matches and related information, or other positive events(s), (ii) paying a subscription fee to the service for an allotted time period covering, say, any number of transmitted text and/or multimedia messages, or perhaps (iii) paying a subscription fee for a predetermined number of SMS and/or MMS messages, all of which may be continued until the customer may decide to unsubscribe from the service.

In yet another example, for instance, the inventive method may employ interactive voice response (“IVR”) technology, wherein one may use a touch-tone phone to interact with a database to acquire information from, or to enter into a database. As is known, such technology does not require human interaction over a phone device, as the user's interaction with a database is predetermined by what the IVR system will allow the user access to, such as systems employed by banks and credit card companies to provide up-to-date account information. As such, IVR technology may also be used to gather information as in the case of telephone surveys and the like in which a user may be prompted to answer a questions(s) by pushing numbers on a touch-tone phone.

In the present inventive method, a service provider may place an advertisement in a public medium to which a would-be customer responds, for example, from a mobile phone device. Upon determination by the service provider that the user has, or is, using a mobile phone device, the service will play a prompt (or “tag”) which may be of the following subject matter:
“If you are calling from a cellular phone, and wish to use this service, please send an SMS text message to short code XXX”, or perhaps the prompt may state,
“If you wish to pay our fee of $XX.XX for service for XX days, please press X followed by the #.”

Upon the customer agreeing to such terms and subscribing to the service as directed, the service may then forward an SMS or MMS message to its new customer acknowledging and/or confirming that such has agreed to accept the offered terms for X days for the stated fee. The service may also inform the new customer that s/he will be billed for such service subscription whether the subscription is used or not. At this point, the customer may be provided access, for example, to a chat line or similar services and the like in accordance with the agreed to terms of the service subscription.

In yet a further aspect of the invention, a customer may create a personalized voice mail message on the IVR system, otherwise referred to as IVR voice mail response, which may be, for instance, an open message describing personal information and personal preferences and the like, or an invitation to meet. In this embodiment, when a person responds to such voice mail message and leaves a response message with the service provider, the user or person placing the original voice mail message may then be notified of such a response via an SMS text or MMS multimedia message from the service provider to the user's mobile phone device. As may be seen in this embodiment, a user of a subscription service may place and leave voice mail or other audio or advertisement material for anyone to hear and, if so desired, to respond to. Such a service may be conducted, for example, in a chat room. A fee may be charged for a user initially leaving a voice mail message, or a user may be availed the opportunity to opt-in for the text or multimedia message notification services. Upon the service receiving anything considered to be a positive response to the voice mail, the user will be forwarded by the service, a text or multimedia message notifying of same. The user may also be presented with various payment options, such as fee payment per message, or s/he may subscribe to a plan which includes a plurality of SMS and/or MMS message notifications. In a preferred embodiment, a service provider will forward an SMS or MMS message to the user almost or substantially immediately, or at least within a substantially short time of receiving notice of positive responses.

In still yet another embodiment, a person would-be subscriber may respond to an advertisement placed for specific content, such as an Internet advertisement for different wallpaper designs, graphics in a phone display or customized ringtone availability, by way of a call or message from a mobile device, or Internet contact. A service provider may then respond via an SMS or MMS message, or for example, by a representative, notifying such would-be purchaser of price information for selected offered items, and if acceptable to the customer to indicate same by pushing XXXX short code in a message field. The service may next respond by way of an SMS or MMS message with information to access a link to download a purchased product or service, such as a ringtone, wallpaper for use with a phone display, games and executable products and services, such as access to dating lines and the like, or a direct call may be placed.

Some non-limiting examples of additional subject matter which may be purchased in such as method can include games, subscriptions to local news as based upon zip code, weather information, sports news, scores, betting lines, handicapping services, lottery information, business and financial news and the like. In a preferred embodiment, a user may forward lottery ticket or raffle ticket identification criteria by phone or SMS/MMS messaging to a service provider, and then be notified by the service provider via an SMS/MMS message whether the ticket is a winner.

As may be seen, the method may also be employed to place bids in an auction, with a service SMS and/or MMS message notification of successful bids, outbids and/or chances or options to place further bids on desired items and services, such that “sniping” may be eliminated or at least curtailed and a desired bid will always be entered. In this embodiment, in a method for the purchase of goods and/or services in an auction-type environment, a user (bidder) answering an advertisement placed by a person or a service provider, or anyone, for the sale of goods and/or services places a bid for said goods and/or services by a cellular phone call, text or multimedia message, wireline call, e-mail, in person or by any means of communication, but makes sure that the user's or bidder's mobile phone number is known to the seller or auction provider. Next, a person or service provider responds to the bidder by way of an SMS text or MMS multimedia message (or EMS message). A multimedia message may be preferable in this embodiment as it allows for images, graphics, pictures, animations and audio as well as text, which makes it possible for different views of an object being auctioned to be forwarded to a bidder or potential bidder, as well as coloring and texture and the like, and further including indications of imperfections, such as rust and discoloration. At this point the sale or transfer of auctioned goods and/or services may be consummated with the bidder winning the auctioned object. Alternatively, the person or service provider responding to the bidder via text or multimedia message to the bidder's mobile phone device informs the bidder that his or her bid has been entered and is either (i) the highest bid submitted at the time, or (ii) the highest bid submitted at the time but not sufficiently high enough to meet a reserve price, or (iii) the user's bid is not sufficiently high enough to overcome bids by others, or (iv) the person or service provider responding to the user's bid via a text or multimedia message to the user's mobile phone device informs said bidder that a bid previously submitted by the user has been outbid by another bidder, and the user is invited and/or solicited to place another higher bid.

As may be appreciated, by way of multimedia messaging with its ability for imaging, graphics, animation and audio in addition to text a tremendous advantage is provided in the telephonic auctioning of goods and/or services, as its versatility is much more advantageous in use than purely web-based auctions such as eBay and the like.

As used herein, SMS messaging is an integrated message service that provides the ability to send and receive messages globally to and from other SMS enabled devices, such as mobile telephones. The system is supported by Global System for Mobiles (GSM) and other mobile connection systems. Using the SMS, a message may be transmitted composed of up to 160 characters of any kind of text in length, and can comprise any combination of words, numbers, alphanumeric, punctuation symbol, or they may also be in non-text, such as binary.

SMS messages are said to be similar to paging systems, except that delivery of SMS messages does not require a mobile phone to be active or even within range. Messages are not sent directly to the recipient but instead are sent to a recipient via a network SMS center, and are held in the SMS center or depository until the intended recipient's phone is active and within range. Thus, SMS messages can always be expected to be delivered to the intended recipient eventually. Another feature of the SMS system is that the sender of an SMS message can receive confirmation of message delivery, or notification of whether the short message has been delivered. In some instances, several short messages can be strung together (concatenated). Various service providers offer different users for the SMS system, such as the Bulk SMS system which can be incorporated into an existing messaging system and used to automate and/or send personalized text messages to local, regional or global recipients. Some applications of this method include peer-to-peer messaging, SMS marketing, alerts, info-text, web-to-mobile content and various notifications. An SMS Gateway system is said to provide developers and integrators access to secure, reliable, international, high capacity SMS messaging platforms, with potential to design and deploy an array of mobile data application through any of several APIs via protocols such as SMPP, HTTP/S, FTB, XML, COM Object and the like.

SMS is used extensively and has been incorporated into existing CRM, e-mail and accounting systems with many expansive applications being reported, all of which are contemplated for use in this inventive method and system, as well as any of the many conventional SMS-based methods and systems.

The multimedia messaging service or MMS as used in mobile communications networks and with the present invention, is the latest approach for transmitting messages having a multimedia content, and is often described as the most recent extension of SMS and EMS messaging protocol. MMS messaging allows messaging between different mobile users and/or between mobile users and the Internet via an e-mail address. Unlike SMS messaging, MMS messaging can include text, sound, images, animations and video. Images may be downloaded from WAP sites, for example, as selected from a menu within a phone, or may be, for instance, photos from a built-in camera in the phone which are commonplace, with MMS capable phones first appearing in 2002.

The present invention also contemplates the employee of Enhanced Messaging Service (“EMS”), a type of halfway service between SMS and MMS which enables some features of MMS capability, such as text, some simple pictures and audio, and some simple graphics and animation.

MMS as a store-and-forward messaging service which allows mobile subscribers the ability to exchange multimedia messages with other mobile subscribers—that is, the ability to send multiple media in a single message and to send the message to multiple recipients. An MMS message can be created, for example, by using a built-in accessory camera, or it may be composed of sound and/or images previously stored in the mobile phone, such as downloaded from an Internet web site. As with SMS, without a phone being turned on an MMS message can be stored and forwarded to a recipient as soon as it is turned on. Additionally, one or multiple of MMS messages can be stored in a user's phone and reviewed or forwarded at a later date. Further, unlike an SMS message which is limited to 160 bytes an MMS message is a single entity as opposed to a collection of attachments and has no size limit. Each MMS message contains a number of pages with each page containing, for example, an image with text and perhaps audio etc., such as a Power Point presentation.

Any conventional, or non-conventional, mobile phone device or the equivalent thereof is also contemplated for use in the inventive method and system, including cell phones from any catalog of the many mobile phone device vendors, some of which have the capability and appearance of a personal computer, or which are generally multifunctional. The inventive method is also contemplated for use with any mobile communication network. Further, a mobile phone device for use with this invention may be Internet-enabled to download product and services purchased from a service provider. Other mobile phone devices are also contemplated for use which may receive purchased products and/or services by receiving, for example, a special type of SMS message called a “Smart Message”, which contains a product or service for installation in a person's cellular phone, such as a customized ring tone, or other product and/or service delivering messages, or mobile phone devices which are equipped with a Melody Composer, for example, for accepting programmable ring tones, or mobile phones equipped in infrared communications (Irda), such as the Nokia brand of cellular phones.

The vending and purchase of any goods and services which can be bought and sold over the telephone are contemplated in conjunction with the present invention and includes any service that can be conducted over telephone lines, such as dedicated or a public telephone system or a wireless telephone system or operation, with some non-limiting examples including, for illustration purposes only, dating services, match making services, chat services, adult content services, technical support or know-how services, language learning, tutoring or other educational services involving a virtually limitless array of subject matter and topics. Further illustrative examples of services offered, bought and sold via the present inventive method and system can include any type of professional service such as legal services, medical services, psychiatric or psychological services, marriage counseling services and counseling services in general, which can be advantageously provided by the invention in an on-the-spot emergency basis if need be. Additional examples of services include gaming, gambling and handicapping services, architectural, business, and accounting and financial services, tax services, credit services and really anything or any type of information that can be sold for a fee.

Examples of goods and/or related services which may be purchased via the present invention, included without limitation, games, phone ring-tones, wallpaper for cellular phone displays, music, movies, and computer software and all executable products, financial products, application products, design and engineering products, drawing and architectural products and any and all search products including personal histories, genealogies, criminal histories, automotive and other product histories, business and credit histories and bank statements and the like. In short, a description of services and goods purchased and/or provided via telephonic associated messages in accordance with the present invention can only be limited by one's imagination.

It is also contemplated that the present invention be used in conjunction with such SMS/EMS/MMS methods as, for example, services which allow for sending and receiving SMS/EMS/MMS messages to and from an application or a person's e-mail, and the transmission of graphics and/or picture images via messaging and the like.

Further contemplated for use herein are any and all network systems and computer software, computer code and hardware for carrying out the operational aspects and embodiments of the invention.

It will also be appreciated by those skilled in the art that the present inventive method and system affords distinct business advantages not previously available to vendors relating to the telephonic sale and transfer of goods and/or services and related information. In this aspect, the present invention provides novel methods of conducting an array of business functions, comprising, designing, manufacturing, using, marketing, selling, licensing, and/or leasing the inventive subject matter, of developing business goodwill, and further providing novel methods of business entity formation, such as partnerships and corporations for conducting the business of the invention.

While the invention has been described in connection with what is presently considered to be the most practical and preferred embodiments, it is to be understood that this invention is not to be limited to the disclosed embodiments in any way which are merely set forth for illustrative purposes. To the contrary, the present inventive method and system, and method for conducting business in general, is intended to cover an array of various modifications and equivalent arrangements all of which are contemplated for inclusion within the spirit and scope of the disclosure and appended claims.

We claim:

1. A method for purchase of goods and/or services comprising the steps of,
(a) a user placing an advertisement through a service provider or vendor, and
(b) the service provider or vendor alerting the user to one or more responses to the advertisement by way of an SMS, EMS and/or MMS message.

2. The method of claim 1 wherein said user is alerted to said response(s) substantially immediately or within a substantially short time of said responses' inception or occurrence.

3. The method of claims 1 and 2 comprising a plurality of SMS, EMS and/or MMS messages which are forwarded to the user relating to the user's agreement or approval thereof to be billed or charged a fee for one or more SMS, EMS and/or MMS messages and/or access to telephonic and/or Internet vendor provided services and/or goods.

4. The method of claim 3 wherein said services and goods are selected from the group consisting of dating services, chat room services, match making services, adult oriented services, technical support or know-how services, tutoring, language learning, and educational services, professional services including legal, medical, business, accounting, tax, engineering and design, antiques and collectibles, psychiatric, psychological, marriage counseling and counseling services in general, gaming and gambling services, handicapping services, computer software and any and all executable products, financial products, application products, banking products, credit products, design and engineering products, design and architectural products, telephone accessories, tolls, fines, music, and any and all search products, including personal histories, credit histories, genealogies, criminal histories, automotive and product histories, and business and credit histories.

5. The method of any of claims 1, 2, 3, and 4 wherein the user may opt-in or opt-out from receiving SMS, EMS, and/or MMS messages or other contact from the service provider.

6. A method of conducting business functions comprising the method of claim 1.

7. A method of conducting business functions comprising the method of claim 2.

8. A method of conducting business functions comprising the method of claim 3.

9. A method of conducting business functions comprising the method of claim 4.

10. A method of conducting business functions comprising the method of claim 5.

11. A method for purchase of goods and/or services comprising the steps of,
(a) a user answering an advertisement placed by a person or a service provider for the sale of goods and/or services with a bid for said goods and/or services,
(b) the person or service provider responding to said bid via an SMS, EMS, or MMS message to the user's mobile phone device, and optionally consummating the sale or transfer of said goods and/or services to the user, or
(c) the person or service provider responding to the user's bid via an SMS, EMS, or MMS message to the user's mobile phone device informing said user that the bid has been received and is either (i) the highest bid submitted at the time, or (ii) the highest bid submitted at the time of but not sufficiently high enough to meet a reserve price, or (iii) the user's bid is not sufficiently high enough to overcome bids by others, or
(d) the person or service provider responding to the user's bid via an SMS, EMS, or MMS message to the user's mobile phone device informing said user that a bid previously submitted by the user has been out bid by another user or bidder, and inviting and/or soliciting the user to place another bid.

12. The method of claim 11 wherein said advertisement is placed in a publicly accessible medium selected from an Internet web page, e-mail, radio, newspaper, magazine, sales advertisement, broadside and telephone.

13. A method of conducting business functions comprising the method of claim 11.

14. A method for the sale or transfer of services and/or goods comprising,
(a) a service provider or vendor placing an advertisement in a publicly accessible medium inviting a response from a member of the public by an SMS, EMS, and/or MMS message to the service provider;
(b) receiving a response from a user to said advertisement by an SMS, EMS, and/or MMS message from a person's mobile phone device querying the advertisement in any way; and
(c) the service provider forwarding an SMS, EMS and/or MMS message to said user concerning information relating to the uses query.

15. The method of claim 14 further comprising one or more steps of the service provider querying the user by an SMS, EMS, and/or MMS message as to personal information selected from personal preferences, personal dislikes, age, gender, race, physical description, sexual preferences, educational history, occupational history, income history, military history, health history, family history, marriage history, athletic history, smoking history, drinking history, group political affiliation history, products desire criteria, services desire criteria, and goods desire criteria, and the user responding to same.

16. The method of claim 15 further comprising the service provider forwarding the user an SMS, EMS, and/or MMS message with content comprising said user's personal information has resulted in a comparison related objectively compatible-predicted match with one or other persons.

17. The method of claim 14 wherein said user may opt-in and our-opt out from receiving SMS, EMS, and/or MMS messages from said service provider.

18. The method of claim 16 wherein said user agrees to pay one or more fees to said service provider for forwarding SMS, EMS, and/or MMS messages to said user relating to predicted matches with other people.

19. The method of claim 18 wherein said user may opt-in and/or opt-out from receiving SMS, EMS and/or MMS messages from said service provider.

20. A method for conducting business functions comprising the method of any of claims 14, 15, 16, 17, and 18.

21. A method for personal contact, searching and/or acquiring services and/or goods comprising the steps of,
(a) a user creating a personal voicemail message, preferably an IVR voice mail message, with a service provider;
(b) a person responding to said personal message; and
(c) said service provider notifying said user by way of an SMS, EMS, and/or MMS message to the user's mobile phone device of said response.

22. The method of claim 21 wherein said SMS message, EMS message, and/or MMS message is forwarded to said user substantially immediately or within a substantially short time of the inception or occurrence of the response.

23. The method of claim 22 wherein said personal voicemail message is related to seeking personal discourse, personal contact, chat, and/or seeking goods and/or services.

24. A method for conducting business functions comprising any of the methods of claims 21, 22 and 23.

25. A method for the purchase of goods and/or services comprising the steps of,
(a) a service provider or vendor placing an advertisement in a publicly accessible medium with contact information;
(b) a user responding to said advertisement by placing a call or an SMS, EMS, and/or MMS message to said contact information from a mobile phone device;
(c) the service provider determining that the user is responding to said advertisement from a mobile phone device, and responding and/or answering said call or SMS, EMS, and/or MMS message by presenting a prompt or tag to the user to: (i) send an SMS, EMS, and/or MMS message to a selected code to receive services and/or goods from the service provider, or (ii) press a coded sequence or character(s) on the user's mobile phone device to receive services and/or goods from the service provider.

26. The method of claim 25 further comprising the steps of wherein in response to said service provider said user forwards and SMS, EMS, and/or MMS message to said service provider concerning fee payment and/or terms to access services and/or goods.

27. The method of claim 25 further comprising the steps of wherein in response to said service provider said user enters one or more characters into her mobile phone device concerning fee payment and/or terms to access services and/or goods.

28. A method of conducting business functions comprising any one of the methods of claims 25, 26 and 27.

29. A system comprising the method of claim 1.

30. A system comprising the method of claim 2.

31. A system comprising the method of claim 3.

32. A system comprising the method of claim 4.

33. A system comprising the method of claim 5.

34. A system comprising the method of claim 6.

35. A system comprising the method of claim 11.

36. A system comprising the method of claim 12.

37. A system comprising the method of claim 14.

38. A system comprising the method of claim 15.

39. A system comprising the method of claim 16.

40. A system comprising the method of claim 17.

41. A system comprising the method of claim 18.

42. A system comprising the method of claim 19.

43. A system comprising the method off claim 21.

44. A system comprising the method of claim 22.

45. A system comprising the method of claim 23.

46. A system comprising the method of claim 25.

47. A system comprising the method off claim 26.

48. A system comprising the method off claim 27.

49. Computer software and hardware for operating the method of claim 1.

50. Computer software and hardware for operating the method of claim 2.

51. Computer software and hardware for operating the method of claim 3.

52. Computer software and hardware for operating the method of claim 4.

53. Computer software and hardware for operating the method of claim 5.

54. Computer software and hardware for operating method of claim 11.

55. Computer software and hardware for operating the method of claim 12.

56. Computer software and hardware for operating the method of claim 14.

57. Computer software and hardware for operating the method of claim 15.

58. Computer software and hardware for operating the method of claim 16.

59. Computer software and hardware for operating the method of claim 17.

60. Computer software and hardware for operating the method of claim 18.

61. Computer software and hardware for operating the method of claim 19.

62. Computer software and hardware for operating the method of claim 21.

63. Computer software and hardware for operating the method of claim 22.

64. Computer software and hardware for operating the method of claim 23.

65. Computer software and hardware for operating method of claim 25.

66. Computer software and hardware for operating method of claim 26.

67. Computer software and hardware for operating the method of claim 27.
